(19) United States
(12) Patent Application Publication
(10) Pub. No.: US 2023/0362665 A1
(43) Pub. Date: Nov. 9, 2023

(54) METHODS AND APPARATUSES FOR UPLINK SIGNAL TRANSMISSIONS

(71) Applicant: LENOVO (BEIJING)LIMITED, Beijing (CN)

(72) Inventors: Lingling XIAO, Beijing (CN); Bingchao LIU, Beijing (CN); Chenxi ZHU, Beijing (CN); Wei LING, Beijing (CN); Yi ZHANG, Beijing (CN)

(21) Appl. No.: 18/040,366

(22) PCT Filed: Aug. 5, 2020
(86) PCT No.: PCT/CN2020/107073

§ 371 Date: Feb. 2, 2023

(51) Int. Cl. H04W 16/28; H04W 72/1268; H04W 72/232

(52) U.S. Cl. CPC H04W 16/28; H04W 72/1268; H04W 72/232

(57) ABSTRACT

Disclosed are methods for an uplink signal transmission. One embodiment of the subject application provides a method performed by a UE, including selecting a Transmission Configuration Indicator (TCI) state from one or more TCI states of one or more Control Resource Sets (CORESETs) in the active bandwidth part (BWP) in a scheduled serving cell, and determining a default spatial relation and/or a default pathloss RS for an uplink signal transmission by an RS with Quasi Co-Location TypeD corresponding to the TCI state. Related apparatuses are also disclosed.

### TECHNICAL FIELD

Various example embodiments relate to methods and apparatuses for uplink signal transmissions.

### BACKGROUND OF THE INVENTION

In 3GPP (3^{rd} Generation Partnership Project), a base station (BS) (e.g., an evolved Node B, an eNB) may configure through higher layer parameters or indicate in DCI a spatial relation and a pathloss reference signal (RS) for an uplink signal transmission according to certain measurement result. An uplink signal is transmitted according to the spatial relation with a transmission power calculated based on the pathloss RS.

### SUMMARY

One embodiment of the subject application provides a method performed by a user equipment (UE), including selecting a Transmission Configuration Indicator (TCI) state from one or more TCI states of one or more Control Resource Sets (CORESETs) in an active bandwidth part (BWP) in a scheduled serving cell, and determining a default spatial relation and/or a default pathloss RS for transmitting an uplink signal by an RS with Quasi Co-Location TypeD corresponding to the TCI state.

Another embodiment of the subject application provides an apparatus, which indicates a non-transitory computer-readable medium having stored thereon computer-executable instructions, a receiving circuitry, a transmitting circuitry, and a processor coupled to the non-transitory computer-readable medium, the receiving circuitry and the transmitting circuitry, wherein the computer-executable instructions cause the processor to implement a method performed by a UE. The method includes selecting a TCI state from one or more TCI states of one or more CORESETs in an active BWP in a scheduled serving cell, and determining a default spatial relation and/or a default pathloss RS for transmitting an uplink signal by an RS with Quasi Co-Location TypeD corresponding to the TCI state.

### BRIEF DESCRIPTION OF THE DRAWINGS

Some example embodiments will now be described, by way of non-limiting examples, with reference to the accompanying drawings.

FIG. 1 illustrates an exemplary CORESET with multiple TCI states.

FIG. 2 illustrates an exemplary method for determining a default spatial relation and/or a default pathloss RS.

FIG. 3 illustrates an exemplary method for selecting a TCI state.

FIG. 4 illustrates an exemplary activated BWP with multiple CORESETs.

FIG. 5 illustrates an exemplary method for selecting a TCI state.

FIG. 6 illustrates an exemplary activated BWP with multiple CORESETs.

FIG. 7 illustrates an exemplary block diagram of a UE according to the embodiments of the subject disclosure.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G and so on. It is contemplated that along with developments of network architectures and new service scenarios, all embodiments in the present application are also applicable to similar technical problems, and moreover, the terminologies recited in the present application may change, which should not affect the principle of the present application.

The present disclosure generally relates to an uplink signal transmission, especially relates to determine a default spatial relation and/or a default pathloss RS for transmitting an uplink signal in which one or more TCI states are activated for one or more CORESETs in the active BWP in the scheduled serving cell.

ABS may configure through the high layer parameters a spatial relation and a pathloss RS for a PUCCH transmission or an SRS signal transmission or indicate in DCI for a PUSCH signal transmission which is scheduled by a DCI format 0_1 or DCI format 0_2 according to certain measurement result, and an uplink signal is transmitted according to the spatial relation with a transmission power calculated based on the pathloss RS.

Conventionally, The UE uses the spatial relation and the pathloss RS corresponding to the dedicated PUCCH signal resource with lowest ID in the active BWP of the serving cell for transmitting the PUSCH signal scheduled by DCI format 0_0.

However, in some cases, the BS may not configure the spatial relation and/or the pathloss RS for a PUCCH or an SRS signal transmission. Furthermore, in some cases, a PUSCH signal transmission is scheduled by DCI format 0_0 but no PUCCH resource is configured in the active BWP or one or more PUCCH resources are configured on the active BWP but each of the PUCCH resource is not configured with a spatial relation. Therefore, the UE may determine the spatial relation and the pathloss RS for an uplink signal transmission.

Generally (e.g., in 3GPP Release 16), only one TCI state is activated for a CORESET in the active downlink (DL) BWP in a Component Carrier (CC) if one or more CORESETs are configured in the active BWP in a scheduled serving cell. If the BS does not configure the spatial relation and/or the pathloss RS but configure the higher layer parameters that enable a UE to apply a default spatial relation and/or a default pathloss RS for an uplink resource transmission (e.g., enableDefaultBeamPlForSRS, enableDefaultBeamPlForPUCCH, enableDefaultBeamPlForPUSCH0_0, and etc.), the UE may determine a default spatial relation and/or a default pathloss RS of an uplink signal according to the TCI state of the CORESET with the lowest ID number (e.g. controlResourceSetld) in the active DL BWP in the CC. The uplink signal may be a dedicated Physical Uplink Control Channel (PUCCH) or a Sounding Reference Signal (SRS) without a configured spatial relation(e.g. higher layer parameters PUCCH-SpatialRelationlnfo or spatialRelationInfo) and/or a configured pathloss RS (e.g. higher layer parameters pathlossReferenceRS or SRS-PathlossReferenceRS), or a Physical Uplink Shared Channel (PUSCH) scheduled by DCI format 0_0 with no PUCCH resources configured or no spatial relation configured for a PUCCH in Radio Resource Control connected (RRC-connected) mode, or etc.

However, in some cases/scenarios, two or more TCI states are activated for a CORESET. For example, in order to improve the reliability and the robustness of a downlink control channel (e.g., a PDCCH) transmission, multiple transceiver points (multi-TRP) and/or multi-panel are used (i.e., multiple beams from multiple transceiver points are transmitted); therefore, two or more TCI states are required to indicate quasi co-location information of the Demodulation Reference Signal (DMRS) port for a reception of the PDCCH signal. Therefore, the UE may select one TCI state among the TCI states, and determine a default spatial relation and/or a default pathloss RS for an uplink signal by an RS with Quasi Co-Location TypeD corresponding to the selected TCI state.

For example, the number of TCI states of a CORESET is only one when conventional PDCCH transmission scheme from a single TRP is used. The number of TCI states of a CORESET is two or more when an enhanced PDCCH transmission scheme with a DCI transmitted on the CORESET from different TRPs is used. In other words, when two or more TCI states of a CORESET are activated, the enhanced PDCCH transmission scheme with a DCI transmitted on the CORESET from different TRPs is implicitly assumed at UE side.

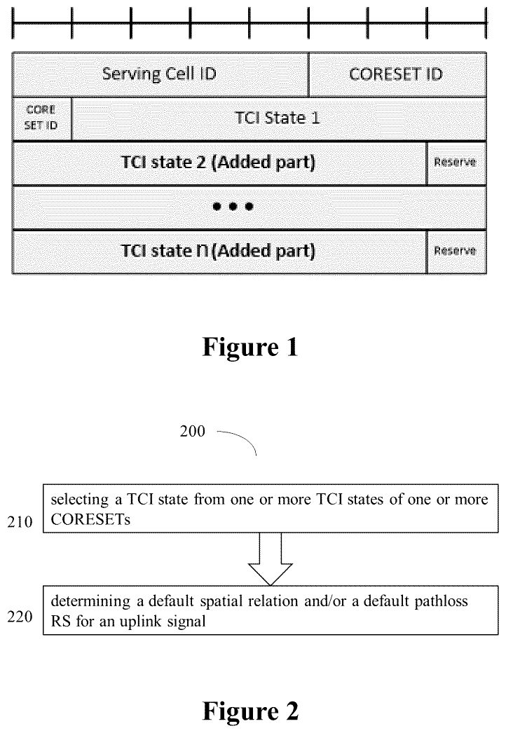

FIG. 1 illustrates an exemplary CORESET with multiple TCI states, where two or more TCI states are used to indicate TCI information for an enhanced PDCCH transmission from two or more TRPs. For the transient period before activation of multiple TCI states and period without activation of multiple TCI states, conventional PDCCH transmission scheme specified in Re1.15 is assumed at UE side and the UE will follow the rules defined in Rel-16 to determine the default spatial relation and/or the default pathloss RS for an uplink signal transmission.

As shown in FIG. 1, the CORESET has a number n of TCI states, n>=2.

Since the UE has no capacity of transmitting an uplink signal with different spatial relations simultaneously, the UE need to select one TCI state and determine the default spatial relation and/or the default pathloss RS for the uplink transmission by an RS with Quasi Co-Location TypeD corresponding to the TCI state.

FIG. 2 illustrates an exemplary method 200 for selecting a TCI state. As shown in FIG. 2, the method 200 may include the step 210 of selecting a TCI state from one or more TCI states of one or more CORESETs in the active BWP in a scheduled serving cell, and a step 220 of determining a default spatial relation and/or a default pathloss RS for an uplink signal transmission by an RS with Quasi Co-Location TypeD corresponding to the TCI state.

In some embodiments, the transmitting power of the uplink signal is calculated based on the default pathloss RS.

In some embodiments, the RS with Quasi Co-Location TypeD for determining the default pathloss RS is a periodic reference signal.

In some embodiments, the uplink signal may be an SRS signal, or a dedicated PUCCH signal without a configured spatial relation (e.g. higher layer parameters spatialRelationInfo or PUCCH-SpatialRelationlnfo) and/or a configured pathloss RS (e.g. higher layer parameters SRS-PathlossReferenceRS or pathlossReferenceRS) but with higher layer parameters that enable a UE to apply a default spatial relation and/or a default pathloss RS for an uplink resource transmission (e.g., enableDefaultBeamPlForSRS, enableDefaultBeamPlForPUCCH, and etc.).

In some embodiments, the uplink signal may be a PUSCH signal scheduled by DCI format 0_0. The UE is in an RRC connection mode, and the UE is configured with one or more PUCCH resources on the active uplink BWP and each of the PUCCH resources is not being provided or activated with a configuration for a spatial relation (e.g. a higher layer parameter PUCCH-SpatialRelationlnfo) and/or a pathloss RS(e.g. a higher layer parameter pathlossReferenceRS)., and is configured to enable a default spatial relation and/or the default pathloss reference RS (e.g., a higher layer parameter enableDefaultBeamPlForPUSCH0_0)for the PUSCH signal, the UE determines the spatial relation and/or the pathloss RS for the PUSCH signal scheduled by DCI format 0_0 according to the method 200.

Moreover, in some embodiments, the uplink signal may be a PUSCH signal scheduled by DCI format 0_0. The UE is in an RRC connection mode, and the UE is without being configured with a PUCCH resource on the active BWP, and is configured to enable the default spatial relation and/or the default pathloss reference RS (e.g., a higher layer parameter enableDefaultBeamPlForPUSCH0_0) for the PUSCH signal, the UE determines the spatial relation and/or the pathloss RS for the PUSCH signal scheduled by DCI format 0_0 according to the method 200.

In some embodiments, in the step 210, the TCI state is selected according to the ID numbers (e.g., TCI-StateIds) of the TCI states and the ID numbers (e.g., controlResourceSetIds) of the CORESET.

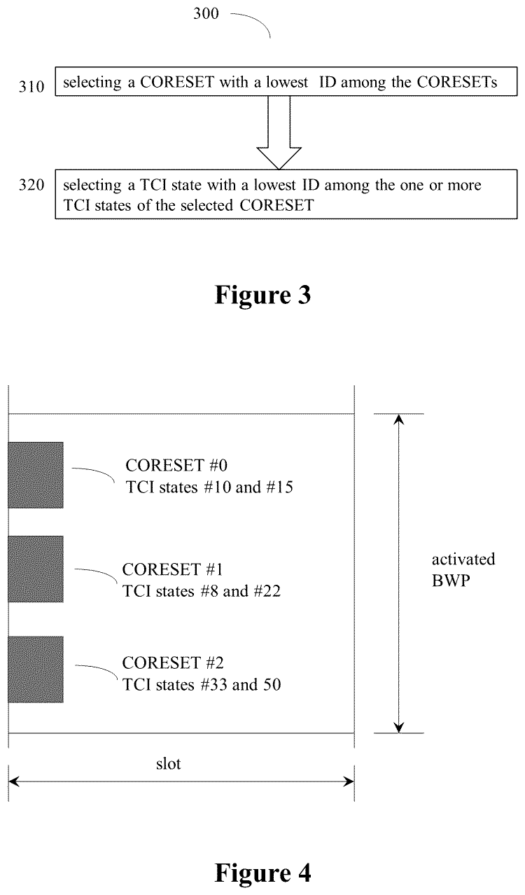

FIG. 3 illustrates an exemplary method 300 for selecting a TCI state in step 210. As shown in FIG. 3, the method 300 may include the step 310 of selecting a CORESET from the one or more CORESETs, wherein the selected CORESET has the lowest ID among all the IDs (e.g.., controlResourceSetIds) of the one or more CORESETs. The method 300 may further include the step 320 of selecting a TCI state from one or more TCI states of the selected CORESET, wherein the selected TCI state has the lowest ID among all the IDs (e.g., TCI-StateIds) of the selected CORESET.

In some embodiments, if a dedicated PUCCH resource is not configured with PUCCH-SpatialRelationlnfo and a UE is not configured pathlossReferenceRS, in case the higher layer parameter enableDefaultBeamPlForPUCCH is set ‘enabled’, the UE determines the default spatial relation for the PUCCH transmission by the Quasi Co-Location TypeD (QCL-TypeD) RS of the TCI state with a lowest ID (e.g., a lowest TCI-StateId) of the CORESET with a lowest controlResourceSetld. The pathloss RS to be used is the periodic QCL-TypeD RS of the TCI state with the lowest ID (e.g., the lowest TCI-StateId) of the CORESET with the lowest controlResourceSetld.

In some embodiments, if an SRS resource is not configured with spatialRelationInfo and a UE is not configured pathlossReferenceRS or SRS-PathlossReferenceRS, in case the higher layer parameter enableDefaultBeamPlForSRS is set ‘enabled’, the UE determines the default spatial relation for the SRS transmission by the QCL-TypeD RS of the TCI state with a lowest ID (e.g., a lowest TCI-StateId) of the CORESET with a lowest controlResourceSetld. The pathloss RS to be used is the periodic QCL-TypeD RS of the TCI state with lowest ID (e.g., the lowest TCI-StateId) of the CORESET with the controlResourceSetld.

In some embodiments, for a PUSCH scheduled by DCI format 0_0, for both cases a UE is not configured with a PUCCH resource on the active UL BWP in RRC connected mode and a UE is configured with one or more PUCCH resources on the active BWP but each of the PUCCH resources is not configured with a spatial relation, if the higher layer parameter enableDefaultBeamPlForPUSCH0_0 is set ‘enabled’, the UE determines the default spatial relation for the PUSCH transmission by the QCL-TypeD RS of the TCI state with a lowest ID (e.g., a lowest TCI-StateId) of the CORESET with a lowest controlResourceSetld. The pathloss RS to be used is the periodic QCL-TypeD RS of the TCI state with lowest ID (e.g., the lowest TCI-StateId) of the CORESET with the lowest controlResourceSetld.

FIG. 4 illustrates an example for selecting a TCI state according to the method 300. In this example, threes CORESETs are configured in the active BWP and the Medium Access Control-Control Element (MAC-CE) activates the one or more TCI states for each CORESET. TCI state #10 and TCI state #15 are activated for CORESET #0, TCI state #8 and TCI state #22 are activated for CORESET #1, TCI state #33 and TCI state #50 are activated for CORESET #2. The UE is in RRC connected mode and the higher layer parameter enableDefaultBeamPlForPUSCH0_0 is set “enabled”, but the UE is not configured with any PUCCH resource on the active UL BWP. If DCI format 0_0 #0 transmitted on CORESET #3 schedules a PUSCH #0 transmission, the UE need to select one TCI state for determining the spatial relation and the default pathloss RS for transmitting PUSCH #0.

According to the method 300, the CORESET having the lowest ID is CORESET #0, the TCI state having the lowest ID of CORESET #0 is TCI state #10. Therefore, in FIG. 4, TCI state #10 is selected for determining the default spatial relation and/or the default pathloss RS for a PUSCH #0 signal transmission. That is to say, a PUSCH #0 is transmitted according to the spatial relation with a reference to the RS with “QCL-Type-D” corresponding to TCI state #10 and the transmission power of the PUSCH #0 is determined by the default pathloss RS with a reference to an RS resource index q_{d} providing a periodic RS resource with “QCL-Type-D” in the TCI state #10.

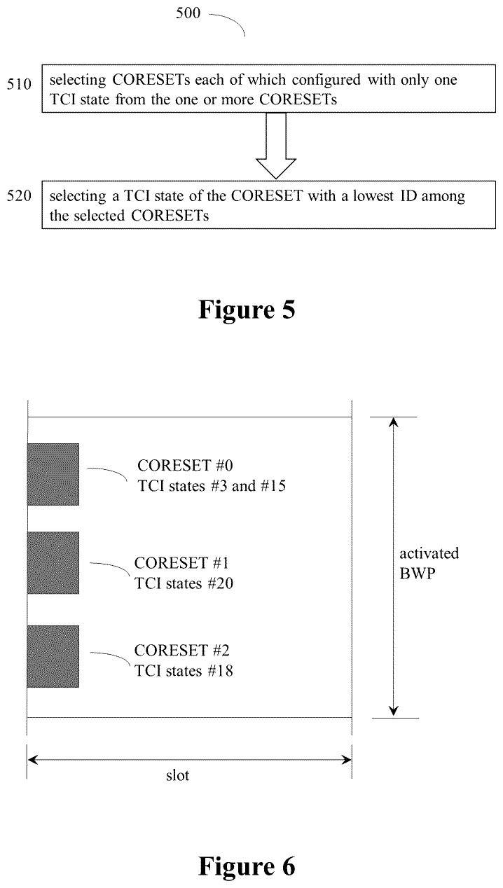

FIG. 5 illustrates an exemplary method 500 for selecting a TCI state in step 210. As shown in FIG. 5, the method 500 may include the step 510 of selecting CORESETs from the one or more CORESETs, wherein each of the selected CORESET is configured with only one TCI state. The method 500 may also include the step 520 of selecting a TCI state of a CORESET with a lowest ID (e.g. a lowest controlResourceSetId) among the selected CORESETs.

In some embodiments, if a dedicated PUCCH resource is not configured with PUCCH-SpatialRelationlnfo and a UE is not configured pathlossReferenceRS, in case the higher layer parameter enableDefaultBeamPlForPUCCH is set ‘enabled’, the UE determines the default spatial relation for the PUCCH transmission by the QCL-TypeD RS of the TCI state of the CORESET with the lowest controlResourceSetId among the one or more CORESETs configured with one TCI state. The pathloss RS to be used is the periodic QCL-TypeD RS of the TCI state of the CORESET with the lowest controlResourceSetId among the one or more CORESETs configured with one TCI state.

In some embodiments, if an SRS resource is not configured with spatialRelationInfo and a UE is not configured pathlossReferenceRS or SRS-PathlossReferenceRS, in case the higher layer parameter enableDefaultBeamPlForSRS is set ‘enabled’, the UE determines the default spatial relation for the SRS transmission by the QCL-TypeD RS of the TCI state of the CORESET with the lowest controlResourceSetld among the one or more CORESETs configured with one TCI state. The pathloss RS to be used is the periodic QCL-TypeD RS of the TCI state of the CORESET with the lowest controlResourceSetld among the one or more CORESETs configured with one TCI state.

In some embodiments, for a PUSCH scheduled by DCI format 0_0, for both cases a UE is not configured with a PUCCH resource on the active UL BWP in RRC connected mode and a UE is configured with one or morePUCCH resources on the active BWP but each of the PUCCH resources is not configured with a spatial relation, if the higher layer parameter enableDefaultBeamPlForPUSCH0_0 is set ‘enabled’, the UE determines the default spatial relation for the PUSCH transmission by the QCL-TypeD RS of the TCI state of the CORESET with the lowest controlResourceSetld among the one or more CORESETs configured with one TCI state. The pathloss RS to be used is the periodic QCL-TypeD RS of the TCI state of the CORESET with the lowest controlResourceSetld among the one or more CORESETs configured with one TCI state.

FIG. 6 illustrates an example for selecting a TCI state according to the method 500. In this example, the threes CORESETs are configured on the active BWP and the MAC-CE activates the one or more TCI states for each CORESET. TCI state #3 and TCI state #15 are activated for CORESET #0, TCI state #20 is activated for CORESET #1, and TCI state #18 is activated for CORESET #2. The UE is in RRC connected mode and the higher layer parameter enableDefaultBeamPlForPUCCH is set “enabled.” If the UE is not configured with PUCCH-SpatialRelationlnfo and is not configured with pathlossReferenceRS in PUCCH-PowerControl, the UE needs to select one TCI state for a PUCCH signal transmission.

According to the method 500, the CORESETs having only one TCI state are CORESET #1 and CORESET #2. Therefore, in FIG. 6, TCI state #20 of CORESET #1 is selected for determining the default spatial relation and/or the default pathloss RS for a PUCCH signal transmission. That is to say, a PUCCH signal is transmitted according to the spatial relation with a reference to the RS with ‘QCL-Type-D’ corresponding to TCI state #20 and the transmission power of the PUCCH signal is calculated by the default pathloss RS with a reference to an RS resource index q_{d} is determined for providing a periodic RS resource with ‘QCL-TypeD’ in the TCI state #20.

The present invention also includes other reasonable methods for selecting a TCI state for uplink signal transmission according to one or more CORESETs on an activated BWP.

The various methods of the present invention may be used in scenarios with multiple TRPs, such as enhanced PDCCH scenario, to improve the reliability and robustness of transmission.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

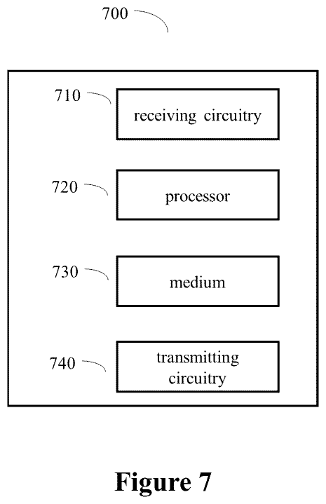

FIG. 7 illustrates a block diagram of a UE 700 according to the embodiments of the subject disclosure. The UE 700 may include a receiving circuitry, a processor, and a transmitting circuitry. In one embodiment, the UE may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement the steps shown in the method 200 or the aforementioned embodiments with the receiving circuitry, the transmitting circuitry and the processor.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. User equipment (UE), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry;
wherein the computer-executable instructions cause the processor to implement a method, the method comprising:
selecting one Transmission Configuration Indicator (TCI) state from one or more TCI states of Control Resource Sets (CORESETs) with a lowest identification (ID) number in an active bandwidth part (BWP) in a scheduled serving cell; and
determining a default spatial relation and/or a default pathloss reference signal (RS) for transmitting an uplink signal by an RS with Quasi Co-Location TypeD corresponding to the TCI state.

2. The UE of claim 1, further comprising:
transmitting the uplink signal according to the default spatial relation with a transmission power calculated based on the default pathloss RS.

3. The UE of claim 1, wherein the RS with Quasi Co-Location TypeD for determining the default pathloss RS is a periodic reference signal.

4. (canceled)

5. The UE of claim 1, wherein the selection of the TCI state from the one or more TCI states of the one or more CORESETs in the active BWP in the scheduled serving cell comprises:
selecting a TCI state of a CORESET with a lowest ID number among one or more CORESETs configured with one TCI state among the one or more CORESETs as the TCI state.

6. The UE of claim 1, wherein the uplink signal is a Sounding Reference Signal (SRS) signal.

7. The UE of claim 6, wherein the UE is not provided or activated with a configuration for a spatial relation and/or a pathloss RS for the SRS signal, and the UE is configured to enable a default spatial relation and/or a default pathloss reference RS for the SRS signal.

8. The UE of claim 6, further comprising:
transmitting an SRS signal according to the default spatial relation with a transmission power calculated based on the default pathloss RS.

9. The UE of claim 1, wherein the uplink signal is a dedicated Physical Uplink Control Channel (PUCCH) signal.

10. The UE of claim 9, wherein the UE is not provided or activated with a configuration for a spatial relation and/or a pathloss RS for the PUCCH signal, and the UE is configured to enable a default spatial relation and/or a default pathloss reference RS for the PUCCH signal.

11. The UE of claim 9, further comprising:
transmitting a PUCCH signal according to the default spatial relation with a transmission power calculated based on the default pathloss RS.

12. The UE of claim 1, wherein the uplink signal is a Physical Uplink Shared Channel (PUSCH) signal scheduled by DCI format 0_0.

13. The UE of claim 12, wherein:
the UE is configured with PUCCH resources on the active UL BWP and each of the PUCCH resources is not provided or activated with a configuration for a spatial relation, the UE is configured to enable the default spatial relation and/or the default pathloss reference RS for the PUSCH signal; and
the UE is in a Radio Resource Control (RRC) connection mode.

14. The UE of claim 12, wherein:
the UE is not configured with a PUCCH resource on the active BWP;
the UE is configured to enable the default spatial relation and/or the default pathloss reference RS for the PUSCH signal; and
the UE is in an RRC connection mode.

15. The UE of claim 14, further comprising:
transmitting a PUSCH signal according to the default spatial relation with a transmission power calculated based on the default pathloss RS.

16. (canceled)

17. The UE of claim 13, further comprising:
transmitting a PUSCH signal according to the default spatial relation with a transmission power calculated based on the default pathloss RS.

18. A method performed by a user equipment (UE), the method comprising:
selecting one Transmission Configuration Indicator (TCI) state from one or more TCI states of Control Resource Sets (CORESETs) with a lowest identification (ID) number in an active bandwidth part (BWP) in a scheduled serving cell; and
determining a default spatial relation and/or a default pathloss reference signal (RS) for transmitting an uplink signal by an RS with Quasi Co-Location TypeD corresponding to the TCI state.

19. The method of claim 18, further comprising:
transmitting the uplink signal according to the default spatial relation with a transmission power calculated based on the default pathloss RS.

20. The method of claim 18, wherein the uplink signal is a Sounding Reference Signal (SRS) signal.

21. The method of claim 18, wherein the uplink signal is a dedicated Physical Uplink Control Channel (PUCCH) signal.

22. The method of claim 18, wherein the uplink signal is a Physical Uplink Shared Channel (PUSCH) signal scheduled by DCI format 0_0.
